(19) United States
(12) Patent Application Publication
(10) Pub. No.: US 2025/0184906 A1
(43) Pub. Date: Jun. 5, 2025

(54) METHODS AND APPARATUSES FOR TRANSMISSION POWER CONTROL

(71) Applicant: Lenovo (Beijing) Limited, Beijing (CN)

(72) Inventors: Jing Han, Beijing (CN); Haipeng Lei, Beijing (CN); Haiming Wang, Beijing (CN); Xiaodong Yu, Beijing (CN)

(73) Assignee: Lenovo (Beijing) Limited, Beijing (CN)

(21) Appl. No.: 18/844,297

(22) PCT Filed: Mar. 8, 2022
(86) PCT No.: PCT/CN2022/079741

§ 371 Date: Sep. 5, 2024

(51) Int. Cl. H04W 52/10; H04B 17/318; H04W 52/24; H04W 92/18

(52) U.S. Cl. CPC H04W 52/10; H04B 17/328; H04W 52/242; H04W 92/18

(57) ABSTRACT

Disclosed are methods and apparatuses for user equipment (UE) transmission power control. An embodiment of the subject application provides a UE including: calculate a pathloss parameter based at least on an orientation of the UE to a reference location; and perform orientation-based open loop power control (OLPC) based at least partly on a first parameter, a second parameter, and the pathloss parameter, wherein the first parameter and the second parameter are received, with the wireless transceiver, from a serving base station (BS).

### TECHNICAL FIELD

The present disclosure generally relates to wireless communications and especially to transmission power control, e.g., for an unmanned aerial vehicle (UAV).

### BACKGROUND OF THE INVENTION

In the near feature there will be millions of drones flying above towns and cities, operating numerous tasks; therefore, rules and regulations that ensure their safe operation are required. For example, there is a Federal Aviation Administration (FAA) rule or regulation about remote identifier (ID), that is, all drone pilots are required to register their unmanned aerial system (UAS) must operate their aircraft on remote identifier (ID). The remote ID is the ability of a drone in flight to provide identification and location information that can be received by other parties; it is very important for the advancement of drone technology. Remote ID helps the FAA, law enforcement, and other federal agencies find the control station when a drone appears to be flying in an unsafe manner or where it is not allowed to fly. Remote ID also lays the foundation of the safety and security groundwork needed for more complex drone operations. There are variant remote IDs, such as broadcast remote ID, networked remote ID, non-equipped remote ID, and etc. The content of remote ID includes e.g. drone ID, drone location and altitude, drone velocity, control station location and elevation, time mark, emergency status, and etc.

### SUMMARY

The present disclosure provides various methods and apparatuses for SL transmission power control for e.g., an unmanned aerial vehicle (UAV).

Some embodiments of the present disclosure provide a user equipment (UE) including: a processor; and a wireless transceiver coupled to the processor, wherein the processor is configured to: calculate a pathloss parameter based at least on an orientation of the UE to a reference location; and perform orientation-based open loop power control (OLPC) based at least partly on a first parameter, a second parameter, and the pathloss parameter, wherein the first parameter and the second parameter are received, with the wireless transceiver, from a serving base station (BS).

In some embodiments, the first parameter is a target receiving power at the serving BS, and the second parameter is a factor associated with pathloss compensation.

In some embodiments, the reference location is ground, or a take-off point, or sea level, and the orientation of the UE to the reference location comprises an above ground level (AGL) height of the UE, or a relative vertical height of the UE to the take-off point, or an above sea level (ASL) height of the UE.

In some embodiments, the first parameter and the second parameter are dedicated per height range for the orientation-based OLPC.

In some embodiments, the first parameter and the second parameter are for terrestrial SL communication if the height of the UE is within a height range.

In some embodiments, to perform the orientation-based OLPC, the processor is further configured to: calculate a power based at least partly on the first parameter, the second parameter, and the pathloss parameter; and select a minimum from the calculated power and a configured maximum transmission power for the orientation-based OLPC as a transmission power.

In some embodiments, the configured maximum transmission power is dedicated per height range.

In some embodiments, the calculated power is further adjusted by a factor received from the serving BS.

In some embodiments, the calculation of the pathloss parameter and the performing of the orientation-based OLPC are enabled by a signal received from a BS.

In some embodiments, the signal is a radio resource control (RRC) message or a medium access control (MAC) control element (CE).

In some embodiments, the calculation of the pathloss parameter and the performing of the orientation-based OLPC are enabled in response to that the height of the UE is above a height threshold.

In some embodiments, the calculation of the pathloss parameter and the performing of the orientation-based OLPC are enabled in response to that signals from a number of cells are above a threshold or in response to fulfill a condition and the number of the cells are above a threshold.

In some embodiments, the reference location is a location of a reference BS, and the pathloss parameter is calculated based on a pathloss between the UE and the reference BS.

In some embodiments, the first parameter and the second parameter are dedicated for the orientation-based OLPC.

In some embodiments, the first parameter and the second parameter are for terrestrial SL communication.

In some embodiments, the first parameter and the second parameter are associated with the reference BS.

In some embodiments, the reference BS is assigned by the serving BS based at least on a location report transmitted from the UE, and/or a planned flight path reported by the UE, and/or a measurement report transmitted from the UE.

In some embodiments, the processor is further configured to determine the reference BS among BSs within a configured BS list received from the serving BS based at least on three-dimension distances between the UE and BS(s) in the configured BS list.

In some embodiments, the processor is further configured to determine the reference BS based at least on reported flight path information.

In some embodiments, the processor is further configured to determine the reference BS among BSs within a configured BS list received from the serving BS based at least on measurements of signals received from the BSs.

In some embodiments, the signals are reference signal received power (RSRP) or reference signal received quality (RSRQ), and the reference BS is a BS among the BSs with maximum RSRP or RSRQ.

In some embodiments, the reference BS is a BS among the BSs with minimum pathloss. Some embodiments of the present disclosure provide a base station (BS) including: a transmitter; a receiver; and a processor coupled to the transmitter and the receiver, wherein the transmitter is configured to transmit a signal indicating whether to turn off an RF component of a UE.

Some embodiments of the present disclosure provide a BS including: a processor; and a wireless transceiver coupled to the processor, wherein the processor is configured to: transmit, with the wireless transceiver, a first parameter and a second parameter to a UE for orientation-based OLPC performed on the UE based at least on an orientation of the UE to a reference location.

In some embodiments, the first parameter is a target receiving power at the serving BS, and the second parameter is a factor associated with pathloss compensation.

In some embodiments, the reference location is ground, or a take-off point of the UE, or sea level, and the orientation of the UE to the reference location comprises an AGL height of the UE, or a relative vertical height of the UE to the take-off point, or an ASL height of the UE.

In some embodiments, the first parameter and the second parameter are dedicated per height range for the orientation-based OLPC.

In some embodiments, the first parameter and the second parameter are for terrestrial SL communication if the height of the UE is within a height range.

In some embodiments, the processor is further configured to transmit a maximum transmission power for the UE to select a transmission power.

In some embodiments, the configured maximum power is dedicated per height range.

In some embodiments, the processor is further configured to transmit, with the wireless transceiver, a factor for the UE to adjust a calculated power for the orientation-based OLPC.

In some embodiments, the processor is further configured to enable the orientation-based OLPC on the UE by transmitting a signal with the wireless transceiver.

In some embodiments, the signal is an RRC message or an MAC CE.

In some embodiments, the orientation-based OLPC is enabled by the UE.

In some embodiments, the reference location is a location of a reference BS.

In some embodiments, the first parameter and the second parameter are dedicated for the orientation-based OLPC.

In some embodiments, the first parameter and the second parameter are for terrestrial SL communication.

In some embodiments, the first parameter and the second parameter are associated with the reference BS.

In some embodiments, the processor is further configured to assign the reference BS based at least on, with the wireless transceiver, a location report received from the UE, and/or a planned flight path reported by the UE, and/or a measurement report received from the UE.

In some embodiments, the processor is further configured to transmit, with the wireless transceiver, a BS list to the UE for the UE to determine the reference BS among BSs within the BS list.

Some embodiments of the present disclosure provide a method performed by a UE. The method includes calculating a pathloss parameter based at least on an orientation of the UE to a reference location; and performing orientation-based OLPC based at least partly on a first parameter, a second parameter, and the pathloss parameter, wherein the first parameter and the second parameter are received from a serving BS.

In some embodiments, the first parameter is a target receiving power at the serving BS, and the second parameter is a factor associated with pathloss compensation.

In some embodiments, the reference location is ground, or a take-off point, or sea level, and the orientation of the UE to the reference location comprises an AGL height of the UE, or a relative vertical height of the UE to the take-off point, or an ASL height of the UE.

In some embodiments, the first parameter and the second parameter are dedicated per height range for the orientation-based OLPC.

In some embodiments, the first parameter and the second parameter are for terrestrial SL communication if the height of the UE is within a height range.

In some embodiments, the method further includes calculating a power based at least partly on the first parameter, the second parameter, and the pathloss parameter; and selecting a minimum from the calculated power and a configured maximum transmission power for the orientation-based OLPC as a transmission power.

In some embodiments, the configured maximum transmission power is dedicated per height range.

In some embodiments, the calculated power is further adjusted by a factor received from the serving BS.

In some embodiments, the calculation of the pathloss parameter and the performing of the orientation-based OLPC are enabled by a signal received from a BS.

In some embodiments, the signal is an RRC message or an MAC CE.

In some embodiments, the calculation of the pathloss parameter and the performing of the orientation-based OLPC are enabled in response to that the height of the UE is above a height threshold.

In some embodiments, the calculation of the pathloss parameter and the performing of the orientation-based OLPC are enabled in response to that signals from a number of cells are above a threshold or in response to fulfill a condition and the number of the cells are above a threshold.

In some embodiments, the reference location is a location of a reference BS, and the pathloss parameter is calculated based on a pathloss between the UE and the reference BS.

In some embodiments, the first parameter and the second parameter are dedicated for the orientation-based OLPC.

In some embodiments, the first parameter and the second parameter are for terrestrial SL communication.

In some embodiments, the first parameter and the second parameter are associated with the reference BS.

In some embodiments, the reference BS is assigned by the serving BS based at least on a location report transmitted from the UE, and/or a planned flight path reported by the UE, and/or a measurement report transmitted from the UE.

In some embodiments, the method further includes determining the reference BS among BSs within a configured BS list received from the serving BS based at least on three-dimension distances between the UE and BS(s) in the configured BS list.

In some embodiments, the method further includes determining the reference BS based at least on reported flight path information.

In some embodiments, the method further includes determining the reference BS among BSs within a configured BS list received from the serving BS based at least on measurements of signals received from the BSs.

In some embodiments, the signals are RSRPs or RSRQs and the reference BS is a BS among the BSs with maximum RSRP or RSRQ.

In some embodiments, the reference BS is a BS among the BSs with minimum pathloss.

Some embodiments of the present disclosure provide a method performed by a BS. The method includes transmitting a first parameter and a second parameter to a UE for orientation-based OLPC performed on the UE based at least on an orientation of the UE to a reference location.

In some embodiments, the first parameter is a target receiving power at the serving BS, and the second parameter is a factor associated with pathloss compensation.

In some embodiments, the reference location is ground, or a take-off point of the UE, or sea level, and the orientation of the UE to the reference location comprises an AGL height of the UE, or a relative vertical height of the UE to the take-off point, or an ASL height of the UE.

In some embodiments, the first parameter and the second parameter are dedicated per height range for the orientation-based OLPC.

In some embodiments, the first parameter and the second parameter are for terrestrial SL communication if the height of the UE is within a height range.

In some embodiments, the method further includes transmitting a maximum transmission power for the UE to select a transmission power.

In some embodiments, the configured maximum power is dedicated per height range.

In some embodiments, the method further includes transmitting a factor for the UE to adjust a calculated power for the orientation-based OLPC.

In some embodiments, the method further includes enabling the orientation-based OLPC on the UE by transmitting a signal.

In some embodiments, the signal is an RRC message or an MAC CE.

In some embodiments, the orientation-based OLPC is enabled by the UE.

In some embodiments, the reference location is a location of a reference BS.

In some embodiments, the first parameter and the second parameter are dedicated for the orientation-based OLPC.

In some embodiments, the first parameter and the second parameter are for terrestrial SL communication.

In some embodiments, the first parameter and the second parameter are associated with the reference BS.

In some embodiments, the method further includes assigning the reference BS based at least on a location report received from the UE, and/or a planned flight path reported by the UE, and/or a measurement report received from the UE.

In some embodiments, the method further includes transmitting a BS list to the UE for the UE to determine the reference BS among BSs within the BS list.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary remote ID broadcasting according to some embodiments of the present disclosure.

FIG. 2 illustrates an exemplary method performed by a UE according to some embodiments of the present disclosure.

FIG. 3 illustrates an exemplary height-based open loop power control (OLPC) scenario according to some embodiments of the present disclosure.

FIG. 4 illustrates an exemplary reference-BS-based OLPC scenario according to some embodiments of the present disclosure.

FIG. 5 illustrates an exemplary reference-BS-based OLPC according to some embodiments of the present disclosure.

FIG. 6 illustrates an exemplary method performed by a BS according to some embodiments of the present disclosure.

FIG. 7 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

As aforementioned, there are variant remote IDs for UAVs, such as broadcast remote ID, networked remote ID, and non-equipped remote ID, and etc. The present disclosure mainly focuses on broadcast remote ID.

In some embodiments of the present disclosure, a PC5 interface (i.e., sidelink (SL) transmission) is used to support broadcast remote ID in 3GPP system.

With SL transmission for broadcasting remote id, the transmission power of UAV needs to be controlled. For example, the transmission power should be large enough so that the people e.g. law enforcement or a UE on ground or nearby can receive the remote id that broadcasted by flying unmanned aerial vehicle (UAV) (e.g., a drone). For example, the transmission power should not be too large, because a too large transmission power may result in severe interference to the ground UEs, other UAVs, or neighbor cells, considering a UAV flying in the sky has line of sight (LOS) with a serving cell and neighbor cells.

FIG. 1 illustrates an exemplary scenario for remote ID broadcast according to some embodiments of the present disclosure. As shown in FIG. 1, a UAV flies at a level and altitude, it communicates with a serving BS, and there is an adjacent BS near the UAV. It is contemplated that there may be one or more adjacent cells not shown in FIG. 1. The UAV continuously broadcasts its remote ID to provide identification and location information. A law enforcement officer or a staff of any organization on ground or near the UAV monitors the UAB via reception of the remote ID the UE broadcasts by an apparatus. If the transmission power of the UAV for broadcasting the remote ID is small, the law enforcement officer or the staff cannot receive the remote ID; if the transmission power of the UAV is too large, it may result interference to adjacent BS(s), the ground UEs in the serving cell and the adjacent cell(s), and/or other UAVs nearby,

The present application provides various methods for controlling SL transmission power. In some embodiments, the SL transmission power control may be used for broadcasting remote ID for a UAV or a UE having the similar functionality. It is contemplated that the various transmission power control methods described in the present disclosure may provide teachings in other scenarios.

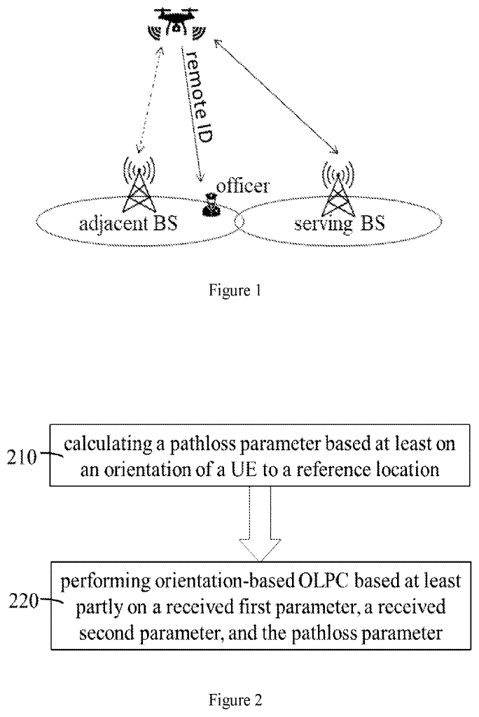

FIG. 2 illustrates an exemplary method 200 performed by a UE for orientation-based OLPC according to some embodiments of the present disclosure. Hereinafter, a UE performing method 200 may refers to a UAV, or a device have the similar ability, or an unmanned device that can fly in the air and have wireless communication ability.

As illustrated in FIG. 2, the method 200 includes operation 210 and operation 220. In operation 210, the UE calculates a pathloss parameter based at least on an orientation of the UE to a reference location. In operation 220, the UE performs orientation-based OLPC based at least partly on a first parameter, a second parameter, and the calculated pathloss parameter; herein the first parameter and the second parameter are received from a serving BS.

According to some embodiments of method 200, the orientation-based OLPC is a kind of height-based OLPC; the reference location may be ground, take-off point of the UE, sea level, or other reference points; the orientation of the UE to the reference location may be an AGL height of the UE, or a relative vertical height of the UE to the take-off point (i.e., a vertical height of the UE to the horizontal plane where the take-off point of the UE is located), an ASL height of the UE, or the like. For concise and simplicity, a vertical height may be referred to as a height, and a relative vertical height may be referred to as a relative height, a vertical height of the UE to the reference location may be referred to as a height of the UE.

According to some embodiments of method, the orientation-based OLPC is a reference-BS-based OLPC; the reference location is a location of a reference BS, and the pathloss parameter is calculated based on a pathloss between the UE and the reference BS. In some embodiments, a reference BS may be a nearest BS to the UE among the BSs detected by the UE. In some embodiments, the reference BS may be the serving BS or may be a BS different from the serving BS.

In some embodiments, the first parameter is a target receiving power at a serving BS. In some embodiments, the first parameter is a higher layer parameter P0.

In some embodiments, the second parameter is a factor associated with pathloss compensation. In some embodiments, the second parameter is a higher layer parameter alpha.

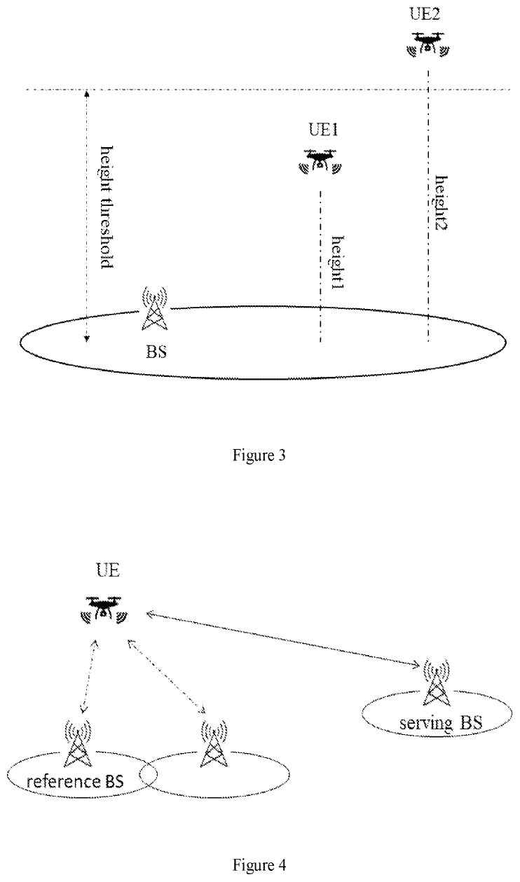

FIG. 3 illustrates an exemplary scenario where the method 200 is performed for height-based OLPC. In this example, the reference location is ground, or a take-off point, or sea level, the orientation of the UE (e.g., UE1 or UE2) to the reference location is a height of the UE to the reference location, such as an AGL height of the UE, or a relative vertical height of the UE to the take-off point, or an ASL height of the UE. As illustrated in FIG. 3, the height of UE1 is height1; the height of UE2 is height2. In some embodiments, UE1 and UE2 are different UEs. In some embodiments, the locations of UE1 and UE2 are the locations of the same flying UE at different time points.

In some embodiments for height-based OLPC, in operation 210, the UE calculates a pathloss parameter based at least on the UE height to the reference location, i.e., the pathloss parameter is associated with the UE height. For example, the pathloss parameter is a function of the UE height, it can be represented by pathloss(height), wherein “height” is the UE height determined by the UE itself.

In some embodiments for height-based OLPC, in operation 220, the UE calculates a power based at least partly on the first parameter, the second parameter, and the calculated pathloss parameter; and then the UE determines a minimum one of the calculated power and a configured maximum transmission power for the height-based OLPC to be a transmission power, e.g., for broadcasting remote ID.

For example, the height-based OLPC transmission power may be expressed by:

$${P}_{tx} = min \{ {P}_{max} , P 0 + alpha * pathloss ( height ) \} \qquad ( 1 )$$

hereinafter:
height is the UE height to a reference location, wherein the reference location is ground, or a take-off point, or sea level
Pₜₓ is the OLPC transmission power;
Pₘₐₓ is a configured maximum transmission power of the UE;
P0 is a target receiving power at a serving BS;
alpha is a factor associated with pathloss compensation.

In some embodiments, Pₘₐₓ is dedicated per height range. For each height range, there is a dedicated Pₘₐₓ configured by the serving BS.

In some embodiments for height-based OLPC, the first parameter and the second parameter are configured by a serving BS. Hereinafter in the description, a parameter “being configured by a serving BS” may refer to that: the parameter may be transmitted in configuration information by the serving BS to the UE via a higher layer signaling, e.g., an RRC signaling or a system information block (SIB), such that the UE may receive the parameter from the BS.

In some embodiments, the first parameter and the second parameter are dedicated per height range. The UE determines its height and an associated height range that the determined height belongs to, and uses the corresponding values of the first parameter and the second parameter associated with the determined height range for height-based OLPC.

For example, if a height of a UAV is within a height range [h1, h2], the first parameter and the second parameter are configured to p0_1 and alpha_1 respectively; if the height of the UAV is within another height range [h2, h3], the first parameter and the second parameter are configured to p0_2 and alpha_2 respectively; herein h1, h2, h3, and h4 are height values to the reference location (e.g., ground, or a take-off point, or sea level, or etc.) e.g., in meters.

In some embodiments for a height-based OLPC of method 200, the UE determines its height and compares the determined height with a configured height threshold. If the UE height is determined to be above the height threshold (e.g., UE2 is above the height threshold as shown in FIG. 3, i.e., height2 is above the height threshold), the first parameter and the second parameter are dedicated per height range; the UE determines an associated height range that the UE height belongs to, and uses the corresponding values of the first parameter and the second parameter associated with the associated height range for height-based OLPC. If the height of the UE is determined to be below a height threshold, the UE may consider itself as on the ground; thus the UE may determine to configure the first parameter (e.g., P0) and the second parameter (e.g., alpha) by reusing corresponding parameters configured for terrestrial SL communication configuration which are for e.g., physical sidelink shared channel (PSSCH).

In some embodiments, a serving BS may adjust the height-based OLPC transmission power to avoid it being too small or too large. For example, the serving BS receives a remote ID broadcast from a UE, in the case the power of the remote ID is too large or too small, the serving BS may transmit a factor delta to the UE for adjusting the transmission power of the UE. For another example, in the case that the serving BS receives an indication from a neighbor BS indicating that the broadcast remote ID results interference to the neighbor cell due to too large power of the remote ID, the serving BS may transmit a factor delta to the UE for adjusting the transmission power of the UE; the adjustment is for reducing the interference of the UE to the network.

In some embodiments, the adjustment may be represented by:

$${P}_{tx} = min \{ {P}_{max} , P 0 + alpha * pathloss ( height ) + delta \} \qquad ( 2 )$$

Hereinafter: delta is a factor for adjusting the transmission power of a UE.

In some embodiments, delta is ±n dB, n is a non-zero value.

In some embodiments, the ability of the UE for performing height-based OLPC may be activated (or enabled) or deactivated (or disabled) by a network. For example, a network (or a serving BS) may transmit a signal to a UE to activate or deactivate the height-based OLPC. In some embodiments, the signal may be an RRC message or an MAC CE.

In some embodiments, the ability of the UE for performing height-based OLPC may be activated (or enabled) by the UE in the case that the UE determines that its height is above a pre-configured or configured height threshold. Hereinafter, a parameter (e.g., the height threshold) or a value being pre-configured may refer to that: the parameter or the value may be hard-wired into the UE or stored on a subscriber identity module (SIM) or universal subscriber identity module (USIM) card for the UE, such that the UE may obtain the first timing offset within the UE.

In some embodiments, the ability of the UE for performing height-based OLPC may be deactivated (or disabled) by the UE in the case that the UE determines that its height is below a pre-configured or configured height threshold.

In some embodiments, the ability of the UE for performing height-based OLPC may be activated (or enabled) by the UE in the case that the number of the cells detected by the UE is above a configured or pre-configured threshold. In other words, if the number of the cells detected by the UE is above a configured or pre-configured threshold, the UE may perform height-based OLPC for e.g., broadcasting remote ID. In some embodiments, a cell is detected by a UE means that an RSRP or RSSI received by the UE from the cell is above a threshold or measurement result(s) for signals received from the cell fulfills a certain condition, e.g., A3, A5, or etc. To some extent, if the number of the cells detected by a UE exceeds a threshold, it means that the location of the UE is relatively high than UEs on the ground.

In some embodiments, the ability of the UE for performing height-based OLPC may be deactivated (or disabled) by the UE in the case that the number of the cells detected by the UE is below a configured or pre-configured threshold. To some extent, if the number of the cells detected by a UE is below a threshold, it means that the location of the UE is not relatively high than UEs on the ground. In some embodiments, if the number of the cells detected by a UE is below a threshold, the UE may determine it is at the reference location, and no height-based OLPC is needed.

FIG. 4 illustrates an exemplary scenario where the method 200 is performed for reference-BS-based OLPC. In this example, the reference location is a location of a BS for reference; herein the reference BS is assigned by the serving BS or determined by the UE itself. The pathloss parameter is calculated based on a pathloss between the UE and the reference BS. It is contemplated that there may be one or more neighbor cells but not shown in FIG. 4. In this example, the reference BS is not the serving BS.

In some embodiments of the method 200 performed for reference-BS-based OLPC, in operation 210, the UE calculates a pathloss parameter based at least on a pathloss between the UE and the reference BS, wherein the pathloss is associated with a three-dimension (3D) distance (referred as to be distance for simplicity and concise) between the UE and the reference BS; in operation 220, the UE performs reference-BS-based OLPC based at least partly on a first parameter, a second parameter and the calculated pathloss parameter, herein the first parameter and the second parameter are configured by a network.

In some embodiments for reference-BS-based OLPC, the first parameter and the second parameter are dedicated for the reference-BS-based OLPC.

In some embodiments for reference-BS-based OLPC, the first parameter and the second parameter are for terrestrial SL communication; in other words, the corresponding parameters for terrestrial SL communication are reused for reference-BS-based OLPC.

In some embodiments for reference-BS-based OLPC, the first parameter and the second parameter are associated with the reference cell; these two parameters may be indicated by the network, or determined by the UE itself based on network configuration and its measurement results.

The present disclosure provides various methods for determining a reference BS for reference-BS-based OLPC. The reference BS may be assigned by a serving BS, or may be determined by the UE itself.

In some embodiments for reference-BS-based OLPC, the UE may transmit a location report to the serving BS; the serving BS may assign a reference BS to the UE based at least on the received location report. In some embodiments, the BS may assign the nearest BS, i.e., the BS nearest to the UE, as the reference BS for the UE. Considering the law enforcement officer around the nearest BS and underneath the UE may monitor the UE as a UAV, it is preferred to determine the first and second parameters based on the nearest BS, i.e., evaluate the pathloss associated with the nearest BS, so as to ensure that the BRID of the UE can be clearly received around the nearest BS. In the case that the UE is moving, the serving BS may change the reference BS based at least on the location of the UE.

In some embodiments for reference-BS-based OLPC, the UE may transmit a planned flight path to the serving BS. Based on the planned flight path, the serving cell may divide the flight path into at least one segment based at least on the neighbor BSs distribution along the flight path, and assign a reference BS for each segment of the flight path.

In some embodiments for reference-BS-based OLPC, a BS nearest to a segment of the flight path may be assigned to be the reference BS when the UE moves onto the segment of the flight path.

FIG. 5 illustrates an example for assigning a reference BS based at least on a planned flight path.

As shown in FIG. 5, the BS divides the flight path into at least two segments: segment1 and segment2 according to neighbor BS distribution; it is contemplated that there may be more segments not shown in FIG. 5. For each segment of the flight path, the serving BS may assign a respective reference BS. In some embodiments, the reference BS assigned for a segment of a flight path is a BS nearest to the segment of the flight path.

For example, as illustrated in FIG. 5, in the case that the UE is within segment1 of the flight path, the serving BS assigns BS1 as the reference BS; in the case that the UE is within segment2 of the flight path, the serving BS assigns BS2 as the reference BS. In some embodiments, BS1 is the nearest BS to the segment1 of the flight path; BS2 is the nearest BS to the segment2 of the flight path.

In some embodiments, the UE may transmit a measurement report to the BS, which includes measurement results of the received signals; the serving BS assigns a reference BS based at least on a measurement report transmitted from the UE. For example, if the measurement result(s) of the signal(s) from a BS is the best among all the measurement result(s) of signal(s) from all the neighbor BSs, the serving BS may assign the BS to be the reference BS for the UE. In the case that the UE is moving, the serving BS may change the reference BS based at least on the location of the UE.

In some embodiments, the serving BS may assign a reference BS based at least on one or a combination of the location report transmitted from the UE, the planed flight path, and/or a measurement report transmitted from the UE.

In some embodiments, the BS may transmit a BS list to the UE, the BS list includes one or more BSs (indicated e.g., by frequency, cell ID, or cell global identifier (CGI)) and their associated horizontal locations and heights. The UE determines its own location and flying height, and then it determines a reference BS for OLPC based at least on the received BS list. In some embodiments, the UE determines a 3D distance between the UE and each BS in the BS list, and determines the nearest cell to be the reference BS.

In some embodiments, the UE may detect a number of BSs nearby. The UE determines its own location and flying height, and then it determines a reference BS for OLPC of the number of detected BSs. In some embodiments, the UE determines a 3D distance between the UE and each BS in the BS list or of the number of detected BSs, and determines the nearest cell to be the reference BS. In the case that the UE is moving, the reference BS determined by the UE may be changing with the UE location.

In some embodiments, there is reported flight path information aligned between the UE and the serving BS, the UE may determine a reference BS for each waypoint of the flight path based at least on the reported flight path information. For each waypoint in the reported flight path, the UE may determine a reference BS of a number of BSs detected by the UE or of a BS list transmitted from the serving BS. For example, the UE determines its own horizontal location and flying height for each waypoint in the report flight path, and then determines the reference BS for each waypoint based at least on the 3D distances between the UE and each BS. In some embodiments, the UE may determine the nearest BS to a waypoint of the flight path to be a reference BS when the UE locates on the waypoint.

Referring back to FIG. 5 again; in this example the UE determines the reference BS by itself. In the case that the UE is on a waypoint within the flight path segment1, the UE determines that BS1 is the reference BS. In the case that the UE is on a waypoint within the flight path segment 2, the UE determines that BS2 is the reference BS. In some embodiments, BS1 is a BS nearest to the flight path segment1, and BS2 is a BS nearest to the flight path segment2.

In some embodiments, the UE measures a downlink (DL) pathloss between the UE and each BS of a BS list transmitted from the serving BS or of a number of BSs detected by the UE, and determines a BS with minimum DL pathloss as the reference BS. In some embodiments, the DL pathloss between the nearest BS and the UE is minimum, and the nearest BS is determined to be the reference BS.

In some embodiments, the UE may determine a BS in a BS list transmitted from the serving BS or of a number of BSs detected by the UE to be the reference BS based at least on measurements of signals received from these BSs. In some embodiments, the signals are RSRP or RSRQ, and the reference BS is a BS among these BSs that has a maximum RSRP or RSRQ. In some embodiments, the RSRP or RSRQ transmitted from the nearest BS is maximum, and the nearest BS is determined to be the reference BS. In the case that the UE is moving, the reference BS determined by the UE may be changing with the UE location.

It is contemplated that BS performs corresponding methods according to some embodiments of the present disclosure.

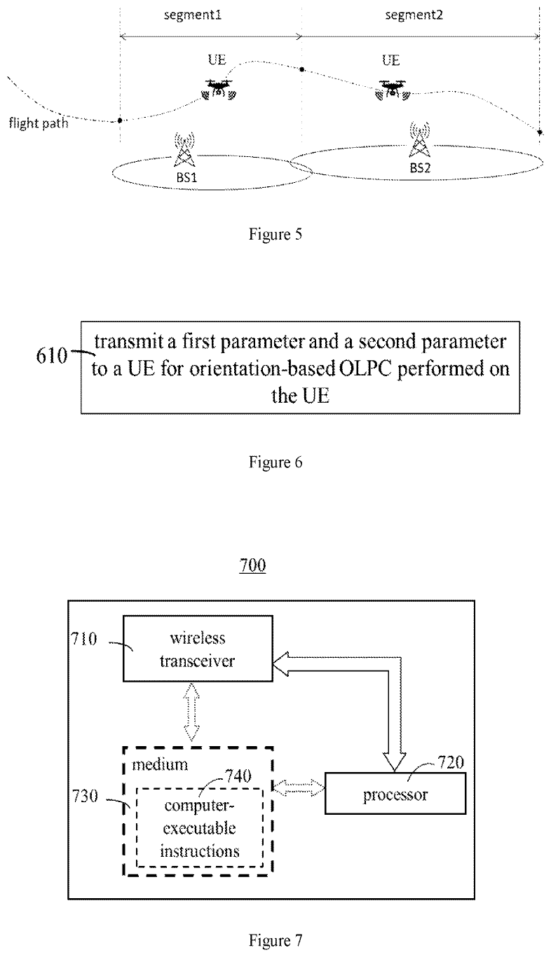

For example, FIG. 6 illustrates an exemplary method 600 performed by a BS for orientation-based OLPC according to some embodiments of the present disclosure. In some embodiments, the orientation-based OLPC may be height-based OLPC. In some embodiments, the orientation-based OLPC may be reference-BS-based OLPC.

As illustrated in FIG. 6, the method 600 includes at least operation 610. In operation 610, the BS transmits a first parameter and a second parameter to a UE for orientation-based OLPC performed on the UE, the orientation-based OLPC performed on the UE is based at least on an orientation of the UE to a reference location. In some embodiments, the UE may refer to a UAV, or a device having the similar ability, or an unmanned device that can fly in the air and have wireless communication ability.

In some embodiments, the BS may activate (or enable) or deactivate (or disable) the orientation-based OLPC functionality of the UE.

In some embodiments for height-based OLPC, the BS may transmit a factor to adjust the UE transmission power based on power of the signal (e.g., broadcast remote ID) received from the UE.

In some embodiments for height-based OLPC, the BS may configure a maximum transmission power for the UE performing the orientation-based OLPC.

In some embodiments for reference-BS-based OLPC, the BS may determine a reference BS for the UE.

According to some embodiments of the present disclosure, orientation-based OLPC is provided for SL transmission power control. In some embodiments, the orientation-based OLPC is height-based OLPC. In some embodiments, the orientation-based OLPC is reference-BS-based OLPC.

According to some embodiments, various methods are provided for determining a reference BS for reference-BS-based OLPC.

It is contemplated that the method provided in the present disclosure is not only for remote ID broadcast, but is also useful for transmission power control on other aspect, as long as it does not violate the spirit of the present disclosure.

FIG. 7 illustrates a simplified block diagram of an exemplary apparatus 700 according to some embodiments of the present disclosure.

In some embodiments, apparatus 700 may be or include at least a part of a UE or similar device that can use the technology of the present disclosure. In some embodiments, the UE may refer to a UAV, or a device having the similar ability, or an unmanned device that can fly in the air and have wireless communication ability.

In some embodiments, apparatus 700 may be or include at least a part of a BS or similar device that can use the technology of the present disclosure.

As shown in FIG. 7, apparatus 700 may include at least wireless transceiver 710 and processor 720, wherein wireless transceiver 710 may be coupled to processor 720. Furthermore, apparatus 700 may include non-transitory computer-readable medium 730 with computer-executable instructions 740 stored thereon, wherein non-transitory computer-readable medium 730 may be coupled to processor 720, and computer-executable instructions 740 may be configured to be executable by processor 720. In some embodiments, wireless transceiver 710, non-transitory computer-readable medium 730, and processor 720 may be coupled to each other via one or more local buses.

Although in FIG. 7, elements such as wireless transceiver 710, non-transitory computer-readable medium 730, and processor 720 are described in the singular, the plural is contemplated unless limitation to the singular is explicitly stated. In certain embodiments of the present disclosure, the apparatus 700 may further include other components for actual usage.

In some embodiments, apparatus 700 is a UE or at least a part of a UE. Processor 720 is configured to cause the apparatus 700 at least to perform, with wireless transceiver 710, any method (e.g., method 200) described above which is performed by a UE according to some embodiments of the present disclosure.

In some embodiments, processor 720 is configured to: calculate a pathloss parameter based at least on an orientation of the UE to a reference location, and perform orientation-based OLPC based at least partly on a first parameter, a second parameter, and the pathloss parameter, wherein the first parameter and the second parameter are received from a serving BS by wireless transceiver 710. In some embodiments, the first parameter is a target receiving power at a serving BS; the second parameter is a factor associated with pathloss compensation. In some embodiments, the first parameter is a higher layer parameter P0, and the second parameter is a higher layer parameter alpha.

In some embodiments, the orientation-based OLPC is height-based OLPC; the reference location is ground, or a take-off point, or sea level, and the orientation of the UE to the reference location comprises an AGL height of the UE, or a relative vertical height of the UE to the take-off point, or an ASL height of the UE. In some embodiments, the first parameter and the second parameter are dedicated per height range for the height-based OLPC; in some embodiments, the first parameter and the second parameter are for terrestrial SL communication if the height of the UE is within a height range. In some embodiments, to perform the orientation-based OLPC, processor 720 is further configured to calculate a power based at least partly on the first parameter, the second parameter, and the pathloss parameter, and select a minimum from the calculated power and a configured maximum transmission power for the orientation-based OLPC as a transmission power. In some embodiments, the calculated power is further adjusted by a factor received from the serving BS by wireless transceiver 710. In some embodiments, the height-based OLPC may be activated (or enable) or deactivated (or disable) by the serving BS based at least on the number of the detected BSs by the UE and/or a height threshold.

In some embodiments, the orientation-based OLPC is reference-BS-based OLPC; the reference location is a location of a reference BS, and the pathloss parameter is calculated by processor 720 based on a pathloss between the UE and the reference BS. In some embodiments, the first parameter and the second parameter are dedicated for the reference-BS-based OLPC. In some embodiments, the first parameter and the second parameter are for terrestrial SL communication. In some embodiments, the first parameter and the second parameter are associated with the reference BS. In some embodiments, the reference BS is assigned by the serving BS based at least on, with wireless transceiver 710, a location report transmitted from the UE, and/or a planned flight path reported by the UE, and/or a measurement report transmitted from the UE. In some embodiments, processor 72 may determine the reference BS based at least on three-dimension distances between the UE and BS(s) in the BS list transmitted from the serving BS or a number of BS(s) detected by processor 720, and/or reported flight path information, and/or measurement results of signals received from the BS(s) in the BS list transmitted from the serving BS or a number of BS(s) detected by the UE. In some embodiments, the nearest BS, or a BS with minimum pathloss, or a BS with maximum RSRP or RSRQ may be determined to be the reference BS.

In some embodiments, the apparatus 700 is a BS or at least a part of a BS. Processor 720 is configured to cause the apparatus 700 at least to perform, with wireless transceiver 710, any method described (e.g., method 600) above which is performed by a BS according to the present disclosure.

According to some embodiments of the present disclosure, the apparatus 700 transmits, with the wireless transceiver 710, a first parameter and a second parameter to a UE for orientation-based OLPC performed on the UE based at least on an orientation of the UE to a reference location. In some embodiments, the first parameter is a target receiving power at a serving BS; the second parameter is a factor associated with pathloss compensation. In some embodiments, the first parameter is a higher layer parameter P0, and the second parameter is a higher layer parameter alpha. The BS may perform various methods corresponding to methods performed by a UE for orientation-based OLPC. In some embodiments, the UE may refer to a UAV, or a device having the similar ability, or an unmanned device that can fly in the air and have wireless communication ability.

In some embodiments, the orientation-based OLPC is height-based OLPC; the reference location is ground, or a take-off point, or sea level, and the orientation of the UE to the reference location comprises an AGL height of the UE, or a relative vertical height of the UE to the take-off point, or an ASL height of the UE.

In some embodiments, the orientation-based OLPC is reference-BS-based OLPC; the reference location is a location of a reference BS, and the pathloss parameter is calculated based on a pathloss between the UE and the reference BS.

In various example embodiments, the processor 720 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 720 may also include at least one other circuitry or element not shown in FIG. 7.

In various example embodiments, the non-transitory computer-readable medium 730 may include at least one storage medium in various forms, such as a volatile memory and/or a non-volatile memory. The volatile memory may include, but is not limited to, for example, a RAM, a cache, and so on. The non-volatile memory may include, but is not limited to, for example, a ROM, a hard disk, a flash memory, and so on. Further, the non-transitory computer-readable medium 730 may include, but is not limited to, an electric, a magnetic, an optical, an electromagnetic, an infrared, or a semiconductor system, apparatus, or device or any combination of the above.

Further, in various example embodiments, the apparatus 700 may also include at least one other circuitry, element, and interface, for example antenna element, and the like.

In various example embodiments, the circuitries, parts, elements, and interfaces in the apparatus 700 may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
calculate a pathloss parameter based at least on an orientation of the UE to a reference location; and
perform orientation-based open loop power control (OLPC) based at least partly on a first parameter, a second parameter, and the pathloss parameter, wherein the first parameter and the second parameter are received from a serving base station (BS).

2. The UE of claim 1, wherein the reference location is ground, or a take-off point, or sea level, and the orientation of the UE to the reference location comprises an above ground level (AGL) height of the UE, or a relative vertical height of the UE to the take-off point, or an above sea level (ASL) height of the UE.

3. The UE of claim 1, wherein the first parameter and the second parameter are dedicated per height range for the orientation-based OLPC.

4. The UE of claim 1, wherein the first parameter and the second parameter are for terrestrial sidelink SL) communication if a height of the UE is within a height range.

5. The UE of claim 1, wherein to perform the orientation-based OLPC, the at least one processor is further configured to cause the UE to:
calculate a power based at least partly on the first parameter, the second parameter, and the pathloss parameter; and
select a minimum from the calculated power and a configured maximum transmission power for the orientation-based OLPC as a transmission power.

6. The UE of claim 5, wherein the configured maximum transmission power is dedicated per height range.

7. The UE of claim 5, wherein the at least one processor is configured to cause the UE to adjust the calculated power by a factor received from the serving BS.

8. The UE of claim 1, wherein calculation of the pathloss parameter and performance of the orientation-based OLPC are enabled in response to a height of the UE is above a height threshold.

9. The UE of claim 1, wherein the reference location is a location of a reference BS, and the pathloss parameter is calculated based on a pathloss between the UE and the reference BS.

10. The UE of claim 9, wherein the at least one processor is further configured to cause the UE to determine the reference BS among BSs within a configured BS list received from the serving BS based at least on one of three-dimension distances between the UE and one or more of the BSs in the configured BS list, or measurements of signals received from the BSs.

11. (canceled)

12. The UE of claim 10, wherein the signals are reference signal received power (RSRP) or reference signal received quality (RSRQ), and the reference BS is a BS among the BSs with maximum RSRP or maximum RSRQ.

13. A base station (BS) for wireless communication, comprising:
at least one memory; and
at least one processor coupled with the at least one memory and configured to cause the BS to transmit a first parameter and a second parameter to a user equipment (UE) for orientation-based open loop power control (OLPC) performed on the UE based at least on an orientation of the UE to a reference location.

14. The BS of claim 13, wherein the reference location is ground, or a take-off point of the UE, or sea level, and the orientation of the UE to the reference location comprises an above ground level (AGL) height of the UE, or a relative vertical height of the UE to the take-off point, or an above sea level (ASL) height of the UE.

15. The BS of claim 13, wherein the at least one processor is further configured to cause the BS to transmit a factor for the UE to adjust a calculated power for the orientation-based OLPC.

16. A processor for wireless communication, comprising:
at least one controller coupled with at least one memory and configured to cause the processor to:
calculate a pathloss parameter based at least in part on an orientation of a user equipment (UE) to a reference location;
receive, from a serving base station, a first parameter and a second parameter; and
perform orientation-based open loop power control (OLPC) based at least in part on the first parameter, the second parameter, and the pathloss parameter.

17. The processor of claim 16, wherein the reference location is one of ground, a take-off point, or sea level, and the orientation of the UE to the reference location comprises one of an above ground level (AGL) height of the UE, a relative vertical height of the UE to the take-off point, or an above sea level (ASL) height of the UE.

18. The processor of claim 16, wherein the first parameter and the second parameter are dedicated per height range for the orientation-based OLPC.

19. The processor of claim 16, wherein the first parameter and the second parameter are for terrestrial sidelink (SL) communication if a height of the UE is within a height range.

20. The processor of claim 16, wherein to perform the orientation-based OLPC, the at least one controller is configured to cause the processor to:
calculate a power based at least in part on the first parameter, the second parameter, and the pathloss parameter; and
select a minimum from the calculated power and a configured maximum transmission power for the orientation-based OLPC as a transmission power.

21. A method performed by a user equipment (UE), the method comprising:
calculating a pathloss parameter based at least in part on an orientation of the UE to a reference location;
receiving, from a serving base station, a first parameter and a second parameter; and
performing orientation-based open loop power control (OLPC) based at least in part on the first parameter, the second parameter, and the pathloss parameter.
